(19) United States
(12) Patent Application Publication
(10) Pub. No.: US 2006/0283162 A1
(43) Pub. Date: Dec. 21, 2006

(54) Fabricating a self-supporting filter element

(75) Inventors: Casey C. Dent, Louisville, KY (US); Richard H. Sommer, Floyds Knobs, IN (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Clarcor Air Filtration Products, Inc., Louisville, KY (US)

(21) Appl. No.: 11/156,811

(22) Filed: Jun. 20, 2005

(51) Int. Cl. B01D 46/10

(52) U.S. Cl. 55/521; 55/499

(57) ABSTRACT

A self-supporting pleated filter, and an apparatus and method for fabricating such a filter, are provided, through use of a conveyor having a plurality of spaced apart flites operatively joined to one another in such a manner that spacing between the flights is selectively adjustable. The conveyor is incorporated into a pleat spacer, according to the invention, so that the pleat spacing of a pleat pack of the filter may be conveniently varied, during manufacture of the filter, to provide a desired pleat spacing, and to also provide a desired fit between the periphery of the pleat pack and a frame, of the filter, which is attached to the pleat pack.

### FIELD OF THE INVENTION

The present invention pertains to pleated air filters, and more particularly to a self-supporting, pleated filter fabricated with an apparatus and by a method allowing the peak-to-peak spacing of the pleats to be adjusted to a desired spacing, during fabrication of the filter.

### BACKGROUND OF THE INVENTION

Pleated air filters often include a pleat pack of porous filter material, formed into a corrugated, accordion-like structure, which is secured within a fiberboard or cardboard frame for use in an air-handling unit. Because such pleated air filters are typically low cost throw-away items, it is highly desirable to produce such pleated air filters using automated machinery and automated processes which allow manufacturing costs of the filter to be minimized.

In order for a pleated air filter to perform satisfactorily, it is necessary that structural features of the pleat pack be held within acceptable tolerances. For example, pleat depth, and uniform peak-to-peak spacing of the pleats are of significant importance, to ensure that the filter will provide a desired filtering and dirt-holding capacity, a desired pressure drop across the filter, and sufficient strength to avoid buckling due to air pressure forces acting against the pleat pack in operation. To preclude leakage of the air to be filtered between the periphery of the pleat pack and the frame, it is also necessary that the outer periphery of the pleat pack fit properly into, and be sealed to the frame of the filter element.

Prior attempts at providing automated machinery for forming such self-supporting pleat packs, and filters including self-supporting filter packs, have not been entirely satisfactory, however. Such prior automated machinery has generally been too complex to be practical, and has not produced the desired degree of control over structural requirements of air filters fabricated with such equipment.

Specifically, prior automated machinery has not provided a practical apparatus or method for readily varying the pleat spacing, to achieve a desired spacing, or to allow for automated cutting of the pleated material at a peak or valley of one of the pleats to reliably and repetitively facilitate attachment of the pleat pack to the frame, substantially without the need for resorting to hand labor.

For the pleat pack of a filter to have a desired pleat depth and peak-to-peak spacing, it is necessary that automated machinery provide mechanisms for forming the pleats in a continuous sheet of porous filter media and holding the pleats in a desired spacing during manufacture of the filter. It is also highly desirable that the automated machinery provide for operation at various desired pleat spacings, without replacement of any parts of the machine, so that filter models having different desired pleat spacings and/or peripheral dimensions can be fabricated on the same automated machine, with little or no time required for changing machine set-up when it is desired to change from manufacturing one filter model to another filter model.

Automated machinery must, therefore be capable of cutting the pleated material to a required length to form the pleat pack, and properly positioning the sides and the leading and trailing edges of the pleat pack so that they can be attached to the frame with an adhesive/sealant.

In order to achieve a proper fit between the pleat pack and the frame, it is highly desirable for automated machinery to provide the capability of adjusting pleat spacing slightly, within acceptable tolerances, so that successive pleat packs may be cut to a desired length through a peak, and/or a valley, of a pleat. The ability to reliably and repetitively cut the pleat packs to length through a peak and/or valley of a pleat ensures that the position of the cut end of the media, and supporting structures attached to the media, at the cut ends of the pleat pack, will be located in a known position on each pleat pack. Having automated machinery and methods that are capable of operation in such a manner that the cut ends of the media and any supporting structures attached to the pleat pack are always located in a known position would greatly facilitate fit-up of the pleat pack to the frame, and allow the process of sealing the pleat pack to the frame to also be automated.

In some prior pleated air filters, fabricated by automated machinery, it was common to form pleat packs from laminated material, having structural elements, such as scrims of metal or plastic mesh, attached to the filter material, in order to provide greater strength and structural stability to the pleat pack during fabrication and operation of the filter. U.S. Pat. Nos. 6,709,480 and 6,521,011, to Sundet et al., U.S. Pat. No. 4,798,575 to Siversson, and U.S. Pat. No. 6,022,305 to Choi, et al., disclose such a construction. In other prior pleated air filters, frames having complex corrugated sections, and/or corrugated rod members, adapted to receive and support the crests of the pleats, are utilized to maintain pleat spacing and provide strength. U.S. Pat. No. 6,159,318, to Choi, discloses such an approach.

Such structural elements in prior filters were sometimes added, out of necessity, to overcome some of the inadequacies of prior automated machinery and methods, and allow the use of automated machinery and methods for at least part of the process of fabricating self-supporting pleated filters. Although some of these prior filter constructions were at least partially amenable to automated construction, their reliance upon structural elements of the type used in the past is undesirable for several reasons. Use of such structures significantly increases the complexity and cost of the pleated filter. Wire and metallic materials used in the past for support structures are not readily incinerable or recyclable, and are therefore undesirable for environmental reasons.

It is desirable, therefore, to provide a filter having a pleat pack which is substantially self-supporting, without resorting to support structures of the type used in the past, and in a form which is readily producible using automated machinery. It is also desirable that both the pleat pack and the filter containing the pleat pack be readily amenable to manufacture with automated machinery. It is further desirable that improved automated machinery and methods be provided, for automated manufacturing of a self-supporting pleated filter.

### BRIEF SUMMARY OF THE INVENTION

The invention provides an improved self-supporting pleated filter, and an improved apparatus and method for fabricating such an improved filter, through use of a conveyor having a plurality of spaced apart flites operatively joined to one another in such a manner that spacing between the flights is selectively adjustable. The conveyor is incorporated into a pleat spacer, according to the invention, so that the pleat spacing of a pleat pack of the filter may be conveniently varied, during manufacture of the filter, to provide a desired pleat spacing, and to also provide a desired fit between the periphery of the pleat pack and a frame, of the filter, which is attached to the pleat pack.

In one form of the invention, an apparatus is provided for fabricating a filter element having a convoluted sheet of filter media including a plurality of pleats forming sloping sides thereof, extending from alternating peeks and valleys. The apparatus includes a pleat spacer having a conveyor for transporting the filter media along a longitudinal axis. The conveyor includes a plurality of flites extending substantially transverse to the longitudinal axis. Each flite of the conveyor has a first end thereof operatively connected to an adjacent flite of the conveyor, and a distal end thereof adapted for engaging a peak of the convoluted sheet, with adjacent flites being spaced apart from one another to form a space there between for receiving a valley of the convoluted sheet there in. The flites of the conveyor are operatively joined to one another in such a manner that spacing between the flites is selectively adjustable, to thereby selectively adjust spacing between the pleats.

An apparatus, according to the invention may further include a media scorer for scoring a continuous sheet of filter media, and a bin disposed between the scorer and the conveyor for receiving the continuous sheet of scored media, and supplying the continuous sheet of scored media to the conveyor. The scorer may generate a plurality of longitudinally spaced, transversely extending, score lines on the continuous sheet of filter media. An apparatus, according to the invention, may also include a pleat inserter for urging the scored media to fold in such a manner that the media enters the spaces between adjacent flites, at every other score line, to thereby form the valley of the pleats.

In a conveyor, according to the invention, adjacent flites may be joined to one another by an articulating linkage having a first and second link, each having a first and second end thereof. The first ends of the first and second links may be respectively joined, in a first articulating joint, to one or the other of the adjacent flites. The second ends of the first and second links may be joined together in a common articulating joint. The first articulating joints may be constrained to follow a first a longitudinal path, and the common articulating joints may be constrained to follow a second longitudinal path, with the second longitudinal path being spaced from and extending generally parallel to the first longitudinal path, with a relative distance between the first and second longitudinal paths being selectively adjustable, to thereby selectively adjust spacing between adjacent flites.

A conveyor, according to the invention, may also include a first guide for directing the first articulating joints along the first longitudinal path, and a second guide for directing the common articulating joints along the second longitudinal path. The conveyor may further include an adjustment apparatus for moving the second guide with respect to the first guide, to thereby change the spacing between the first and second longitudinal paths. In some forms of the invention, a conveyor, according to the invention, may include a plurality of flite support bars, having a first surface thereof adapted for attachment there to of a flite, and a second surface thereof adapted for guidance along the first longitudinal path. The flite support bars may extended substantially transverse to the longitudinal path, and be adapted at first and second ends thereof for articulating attachment of the first ends of adjacent first and second articulating links. The first and second articulating links joining the first ends of the flite support bars thereby form a first, longitudinally running, endless chain. In similar fashion, the first and second articulating joining the second ends of the flite support bars form a second, longitudinally running, endless chain which is transversely spaced by the flite support bars from the first longitudinally running endless chain.

The conveyor may further include a conveyor frame wherein the first guide includes at least one longitudinally extending flite support bar guide for guiding the second surfaces of the flite support bars in such a manner that the first articulating joints are directed along the first longitudinal path. The conveyor frame may further include a pair of second guides, with one second guide operatively mounted adjacent to each of the first and second ends of the flite support bars for guiding the common articulating joints formed by the articulating links at the first and second ends of the flight support bars along respective substantially longitudinal paths.

The flite support bar guides of the conveyor frame may include a substantially flat and straight section thereof, defining a pleat spacing region of the first longitudinal path, disposed upstream from a return portion of the first longitudinal path.

An apparatus, according to the invention may include a pleated media guide, for lifting the pleated media away from the flites prior to the pleated media reaching the return portion of the first longitudinal path. An apparatus, according to the invention, may further include an attachment apparatus for attaching one or more longitudinally extending reinforcement strips to the peak of at least some of the pleats, as they travel through the pleat spacing region of the first longitudinal path.

A conveyor, according to the invention, may include a friction drive mechanism adapted for contacting the second surface of the flite support bars, to thereby urge movement of the support bars, and the first articulating joints attached thereto, along the first longitudinal path. The friction drive mechanism may include an endless belt forming part of the flite support bar guide.

The invention may also take the form of a method for constructing or operating a conveyor or an apparatus, according to the invention. The invention may further take the form of a self-supporting pleated filter having pleats thereof which are spaced, during fabrication of the filter element, by a pleat spacer including a conveyor according to the invention.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a schematic illustration of an exemplary embodiment of an apparatus, in the form of a automated machine, for forming a filter in accordance with the invention.

FIGS. 2A-2C are perspective illustrations of a filter, in accordance with the invention, with FIG. A showing an outflow side of the filter, FIG. 2B showing an inflow side of the filter, and FIG. 3C showing a pleat pack of the filter.

FIG. 3 is a partial cross sectional view of a portion of the filter of FIG. 2A and FIG. 2B.

FIGS. 3B and 3C illustrate problems encountered in fabrication of prior filters produced on automated machinery not having the capability provided by the present invention, of being able to adjust the pleat spacing within tolerance limits to ensure that the pleated media is cut on a peak and/or a valley of the pleated media.

FIG. 4 is a perspective, partially exploded view, of a portion of a conveyor of in a pleat spacer of the exemplary embodiment of the apparatus shown in FIG. 1, showing details of construction of an articulating linkage joining adjacent flites of the conveyor.

FIG. 5 is a perspective view of the conveyor of FIG. 4, with some parts removed, to illustrate construction details of a conveyor frame, and friction drive system of the exemplary embodiment.

FIGS. 6 and 7 are orthographic, partial cross-sectional views, further illustrating specific structural elements and aspects of the conveyor of the exemplary embodiment of FIG. 1.

FIG. 8 is an orthographic side view of a portion of the conveyor of the exemplary embodiment, illustrating an offset between substantially parallel longitudinal paths of first articulating joints and common articulating joints, during operation of the conveyor of the exemplary embodiment for providing desired pleat spacing in a filter, according to the invention.

FIG. 9 is a partial perspective view of a portion of the conveyor, of the exemplary embodiment of the invention, illustrating further structural and functional aspects of the friction drive mechanism, according to the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

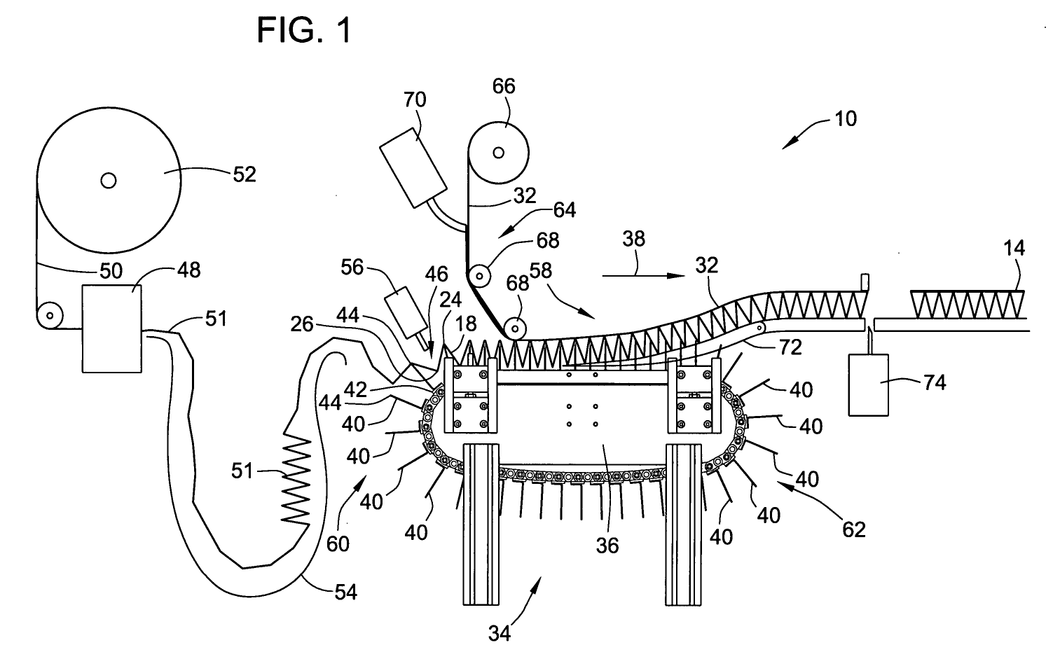

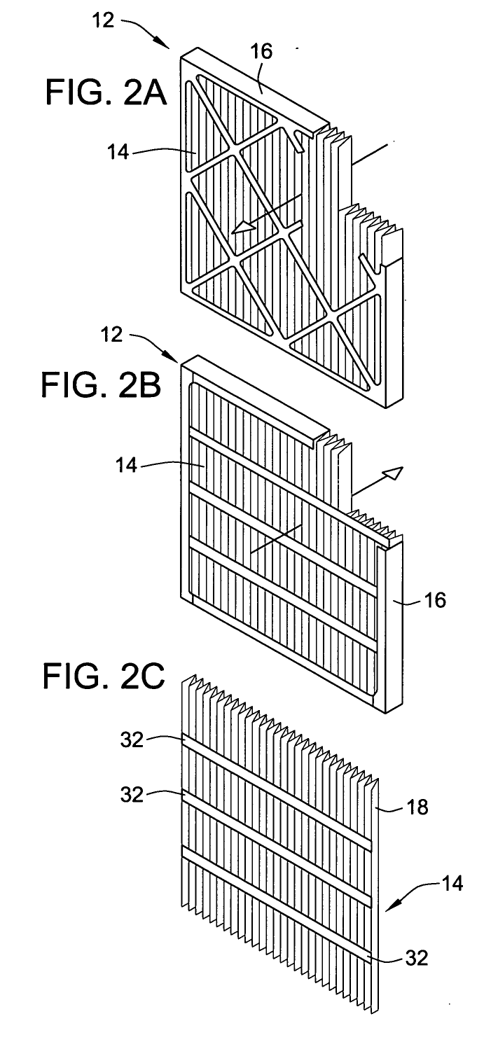

FIG. 1 shows a first exemplary embodiment of an apparatus, according to the invention, in the form of an automated machine 10 for forming an exemplary embodiment of a self-supporting filter 12, according to the invention, as shown in FIGS. 2A and 2B.

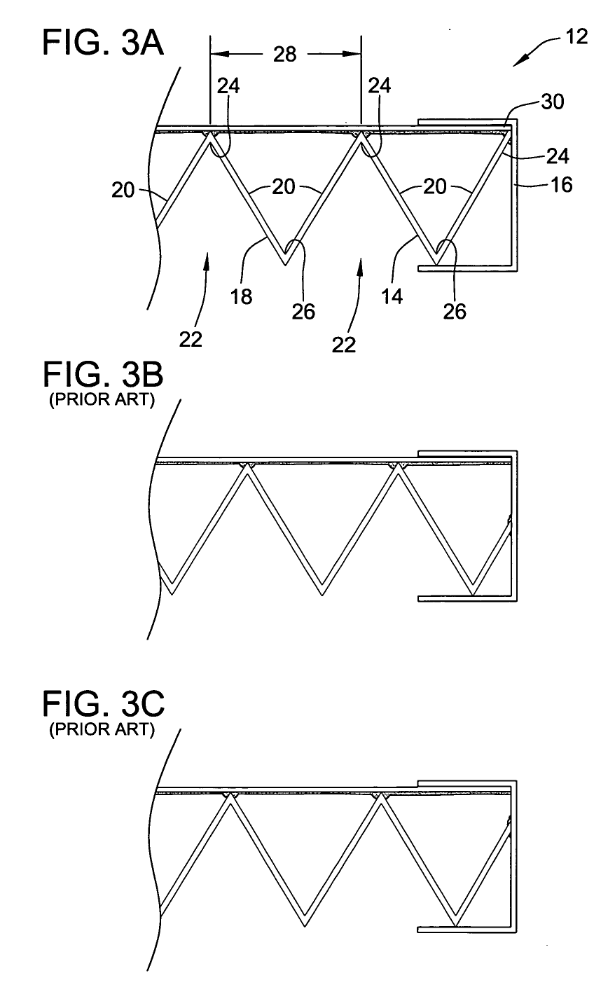

As shown in FIGS. 2A and 2B, the exemplary embodiment of the filter 12 includes a self-supporting pack 14 mounted within a one-piece, die-cut, wrap-around, paperboard frame 16. As shown in FIG. 2C, and FIG. 3A, the pleat pack 14, of the exemplary embodiment, includes a convoluted sheet 18 of porous filter media, having an integer value of half pleats 20 forming sloping sides of a plurality of pleats 22, with the sloping sides of the pleats 22 extending from alternating peaks 24 and valleys 26 of the pleats 22.

As will be described in greater detail below, the pleats 22 are spaced, during fabrication of the filter 12 by a pleat spacer, in accordance with the invention, which includes a conveyor having a plurality of spaced part flites operatively joined to one another in such a manor such that a pleat spacing 28, between adjacent pleats 22 of the pleat pack 14 may be varied during manufacture of the pleat pack 14, to provide a desired pleat spacing 28, and to also provide a desired fit between the periphery of the pleat pack 14 and the frame 16. Specifically, as will be described in more detail below, a pleat spacer of the exemplary embodiment of the automated machine 10 maintains a desired pleat spacing 28, during manufacture of the pleat pack 14. The automated machine 10 allows the pleat spacing to be adjusted slightly, within tolerance limits, in such a manner that the convoluted sheet 18 of filter media may be cut to a desire length, with the cut being positioned at one of the peaks 24 and/or valleys 26, to provide a proper fit for the pleat pack 14 within the frame 16.

Cutting the sheet 18 of pleated material at the peaks 24 and/or valleys 26, facilitates fabrication of the filter 12, by always placing the cut ends of the pleat pack 14 at a known location within the frame 16, to thereby facilitate application of a sealant 30 at the juncture of the pleat pack 14 and frame 16 using automated equipment.

As shown in FIG. 2C, the pleat pack 14 of the exemplary embodiment of the filter 12 also includes several longitudinally extending reinforcement strips 32, of a paper board material, which are secured to the peaks 24 of the pleats 22, and to the frame 16, with spots, or beads, of adhesive as shown in FIG. 3. These longitudinally extending reinforcement strips 32 are attached to the peaks 24 of the pleats 22 during fabrication, by the automated machine 10, in a manner described in greater detail below, for maintaining a desired pleat spacing 28 in the pleat pack 14.

In prior automated machines, not having the capability provided by the present invention to adjust the desired pleat spacing, within tolerance limits, so that the media is always cut at a peak and/or valley, the position of the intersection of the cut end of the media with the frame will vary, from filter to filter, as illustrated in FIGS. 3B and 3C. Such variation makes it impossible to know in advance of cutting each piece of media the point at which a bead of adhesive sealant should be placed on the frame to secure and seal the cut end of the media to the frame. Such variation has heretofore generally precluded the use of automated machinery, in prior filter assembly apparatuses and methods, for making the joint between the cut end of the media and the frame, and has generally necessitated the use of hand labor in making this joint, thereby undesirably increasing cost and reducing reliability of prior filters.

It will also be appreciated that, because the pleat pack 14 of the exemplary present invention can be reliably and repeatedly cut on the peaks 24 of the pleats 22, the reinforcement strips 32 are also simultaneously cut in a manner that provides support for the cut ends of the strips 32, thereby facilitating attachment of the strips 32 to the frame 16, in contrast to the situation existing in the fabrication of prior filters, as illustrated in FIGS. 3B and 3C, where the cut ends of reinforcing strips, similar to the strips 32 of the exemplary embodiment of the filter 12, may be left unsupported. Where the ends of the strips are unsupported, hand labor is generally required to attach the ends of the strips to the frame, in a manner that is readily accomplished by automated machinery in producing the exemplary embodiment of the filter 12 of the present invention.

As shown in FIG. 1, the exemplary embodiment of the automated machine 10 includes a pleat spacer 34, including a conveyor 36 for transporting the convoluted sheet 18 of filter media along a longitudinal axis, generally indicated my arrow 38 in FIG. 1. The conveyor 36 includes a plurality of flites 40 extending substantially transverse to the longitudinal axis 38. Each flite 40 of the conveyor 36 has a first end 42 thereof operatively connected, in a manner described below to an adjacent flite 40 of the conveyor 36. Each flite of the conveyor includes a distal end 44 adapted for engaging a peak 24 of the convoluted sheet 18, with adjacent flites 40 being spaced apart from one another to form a space 46 there between, for receiving a valley 26 of the convoluted sheet 18 therein. The flites 40 of the conveyor 36 are operatively joined to one another in such a manner that the spacing between the flites 40 is adjustable, to thereby selectively adjust spacing between the pleats 22.

As further shown in FIG. 1, the exemplary embodiment of the automated machine 10 also includes a media scorer 48 for scoring a continuous sheet 50 of the filter media, supplied from a roll 52 of the filter media 50, to form a continuous sheet of scored media 51. The media scorer 48 may take any appropriate form known in the art, such as a rotary scorer, or a thermal scorer. In the exemplary embodiment, the scorer 48 generates a plurality of longitudinally spaced, substantially transversely extending, score lines on the continuous sheet of filter media 50.

A bin 54 is disposed between the scorer 48 and the conveyor 36 for receiving the continuous sheet of scored media to the conveyor 36. As is illustrated schematically in FIG. 1, it is not necessary, in practicing the invention, that the scored media 51 be held in any particular orientation prior to being supplied to the conveyor 36. Accordingly, the continuous sheet of scored media 51 may accumulate in the bin 54 in any manner that it chooses, i.e. in either a convoluted or non-convoluted state. As will be understood by those having skill in the art, the ability to allow the scored media 51 to accumulate in this fashion, provides significant advantage, over prior automated machinery for forming pleated filter packs which required that complex mechanisms be provided between a scorer and a pleat spacing mechanism in order to ensure proper shaping of the pleats, and that the pleats were fed into the pleat spacer in a particular orientation.

The exemplary embodiment of the automated machine 10 further includes a pleat inserter 56 for urging the scored media to fold in such a manner that the media enters the spaces 46 between adjacent flites 40, at every other score line, to thereby form the valleys 26 of the pleats 22. In the exemplary embodiment of the automated machine 10 shown in FIG. 1, the pleat inserter 56 takes the form of an air knife. In other embodiments of the invention, however, the pleat inserter 56 may take other appropriate forms such as a guide wheel, with rigid or flexible flaps extending therefrom, for urging the valleys 26 of the scored media 51 into the spaces 46 between adjacent flights of 40 of the conveyor 36.

As shown in FIG. 1, the conveyor 36 is configured in such a manner that the flites 40 travel along a closed path, including a substantially flat and straight section thereof at the top of the conveyor 36, disposed between curved returned portions of the path of the flites 40. The upper flat and straight section of the path of the flites 40 defines a pleat spacing region 58 extending between upstream and downstream curved return portions 60, 62 of the path the flites 40.

The exemplary embodiment of the automated machine 10 includes an apparatus 64 for attaching the longitudinally extending reinforcing strips 32 to the peaks 24 of the convoluted sheet 18 of filter media, while the convoluted sheet 18 is being conveyed through the pleat spacing region 58 of the path of the flites 40. The apparatus 64, for attaching the longitudinally extending reinforcement strips 32, in the exemplary embodiment, includes a plurality of transversely spaced supply rolls 66 (only one of which is visible in FIG. 1) for feeding multiple longitudinally oriented reinforcement strips 32 through a plurality of guide rollers 68 and past adhesive applicator 70 for applying a bead of adhesive to the bottom sides of the strips 32, and for guiding the strips 32 into contact with the peaks 24 of the convoluted filter media 18 within the pleat spacing region 58. Application of reinforcing strips in this manner, is well known in the art, and can be accomplished in any appropriate fashion in practicing the invention, so long as the adhesive is sufficiently set prior to the strip 32 reaching the downstream end of the pleat spacing region 58, so that the strips 32 will maintain the pleat spacing after the convoluted media 18 is lifted free of the flites 40 of the conveyor 36.

A pleated media guide 72 is provided for lifting the pleated media 51, with the longitudinally extending reinforcement strips 32 attached thereto, off of the flites 40, prior to the flites 40 reaching the downstream return section 62 of the path of the flites 40.

After being lifted off of the flites 40, the pleated media 18, with the reinforcement strips 32, attached thereto, proceeds to a cutting apparatus 74, of any appropriate form, such as the guillotine shear 74 shown in FIG. 1, or a saw. The cutting apparatus 74 simultaneously severs the convoluted sheet 18 and reinforcing strips 32, at a peak 24, to form the completed media pack 14, which is then transported to additional automated machinery (not shown), for insertion into the frame 16, to form the completed filter 12.

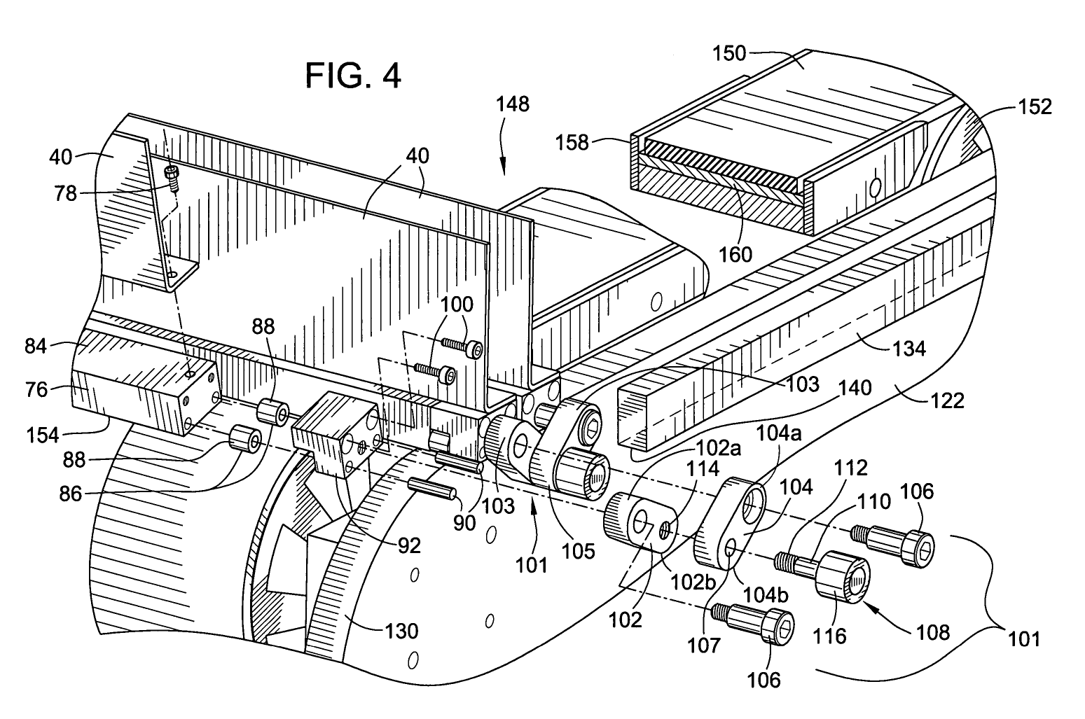

As shown in FIG. 4-7, each of the flites 40 of the conveyor 36, in the exemplary embodiment, includes three separate flite section 40a, 40b, 40c attached to a flite support bar 76 by threaded fasteners 78. The flite sections 40a, 40b, 40c are spaced apart along the flite support bar 76 to form a pair of gaps 80, 82 which allow the flites 40 to pass longitudinally by a first and second pleated media guide 72, only one of which is visible in FIG. 1.

As best seen in FIG. 4, each of the flite support bars 76 includes a first surface 84 thereof, adapted for attachment thereto of a flite 40 with the threaded fasteners 78. Each of the flite support bars 76 also includes a second surface 86 thereof, defined, in the exemplary embodiment, by the outer peripheries of pairs of rollers 88 attached to opposite ends of the flite support bars 76 by dowel pins 90 extending through a removable end cap 92 of the flite support bar 76. The dowel pins 90 are press fit into the removable end cap 92. The dowel pins 90 extend through the rollers 88 and into receptacles in the ends of the flite support bars 76. Two recessed-head screws 100 extend through each end cap 92, to secure each end cap 92 to the remainder of its respective flite support bar 76.

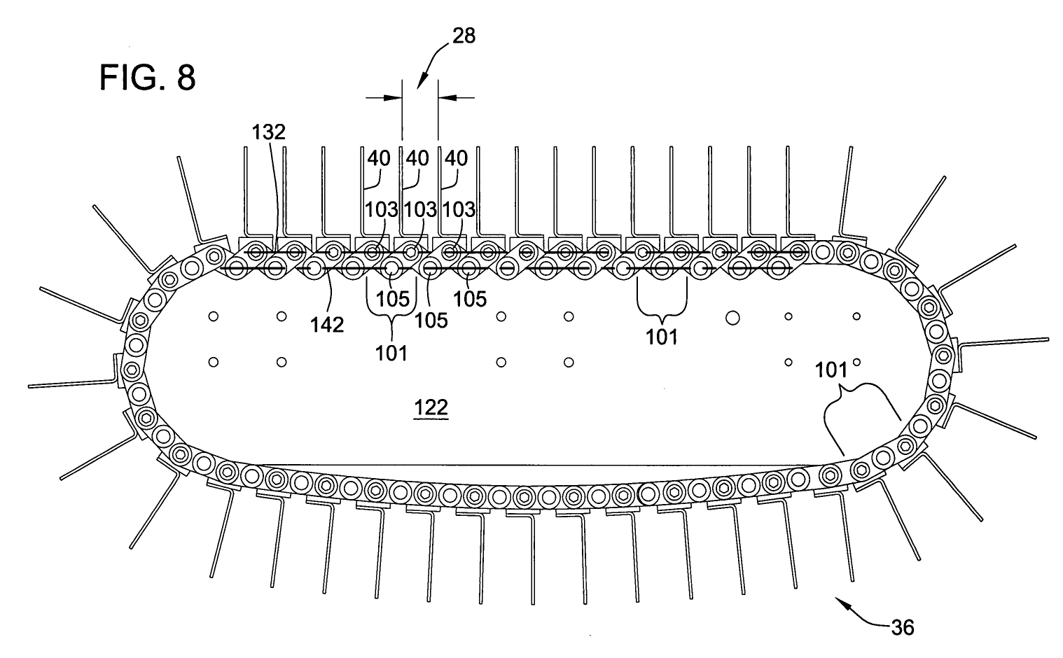

As shown in FIG. 4, and FIGS. 7-8, adjacent flites 40 are operatively joined to one another by an articulating linkage 101 having a first and second link 102, 104. Each of the first and second links 102, 104 includes a first end 102a, 104a thereof, respectively joined in a first articulating joint 103 by a shoulder bolt 106 to the removable end caps 92 of the flite support bars 76 of the adjacent flites 40. The second ends 102b, 104b of the first and second links 102, 104 are joined together in a common articulating joint 105 by a cam follower 108 having a shank portion 110 thereof, which passes through a bore 107 in the second link 104, and a threaded portion 112 thereof, which engages a threaded hole 114 in the second end 102b of the first link 102 of the articulating linkage 101. The cam follower 108 includes a rotateable portion 116 which is mounted for rotation about a common axis of the shank portion 110 and the threaded portion 112 of the cam follower 108.

As will be understood by those having skill in the art, by virtue of the configuration and connection of the articulating linkage 101 joining each pair of adjacent flites 40, of the conveyor 36 of the exemplary embodiment, a first and second endless chain are formed at opposite ends of the flite support bar 76, with only the endless chain 118 at one end of the flite support bar 76 being visible in FIGS. 1 and 8.

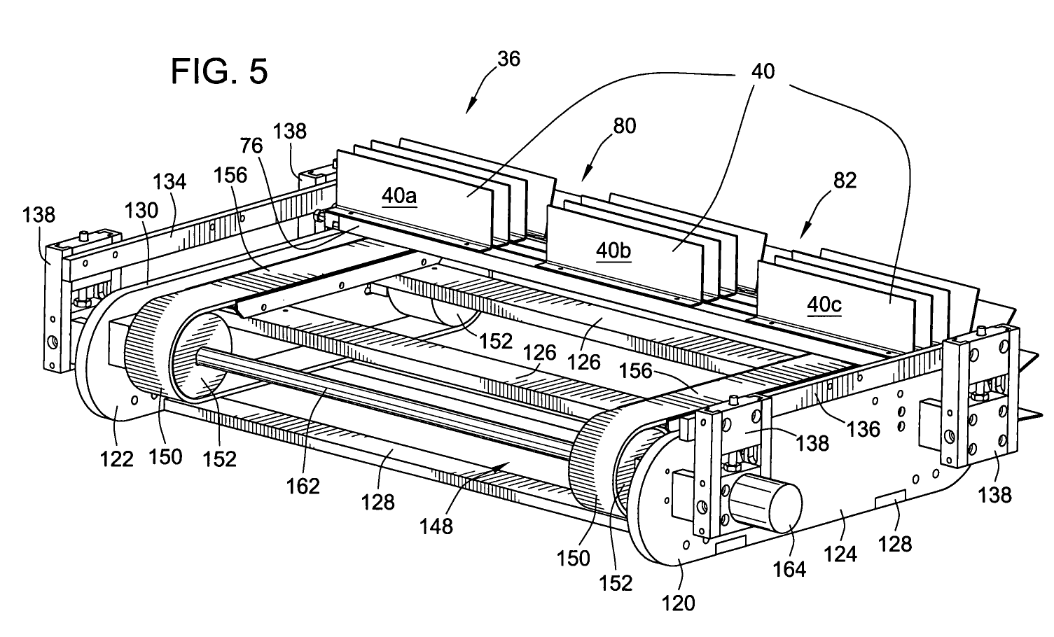

As best seen in FIG. 5, the conveyor 36 of the exemplary embodiment further includes a conveyor frame 120, having a first and second side plate 122, 124 which are joined together by a pair upper transverse frame members 126 and a pair of lower transverse frame members 128. The outer peripheries of the first and second side plates 122, 124 of the conveyor frame 120 are formed in a race-track shape to serve as a pair of first guides 130 for guiding the second surfaces 86 of the flite support bars 76, as defined by the outer periphery of the rollers 88 attached to opposite ends of the flite support bars 76, in such a manner that the first articulating joints 103 are constrained to follow a first longitudinal path 132 indicated by a bold dashed line in FIG. 8.

The conveyor frame 120 further includes a pair of second guides 134, 136, attached to the first and second side plates 122, 124 of the conveyor frame 120 by adjustment apparatuses 138 disposed at both longitudinal ends of the second guides 134, 136. As best seen in FIGS. 4, 6 and 7, a lower surface 140 of the second guides 134, 136 is positioned to bear against the outer periphery of the rotatable portion 116 of the cam followers 108, in such a manner that the common articulating joints 105 are constrained to follow a second longitudinal path 142 (indicated by a bold dashed line in FIG. 8) that is spaced from, and extends generally parallel to the first longitudinal path 132.

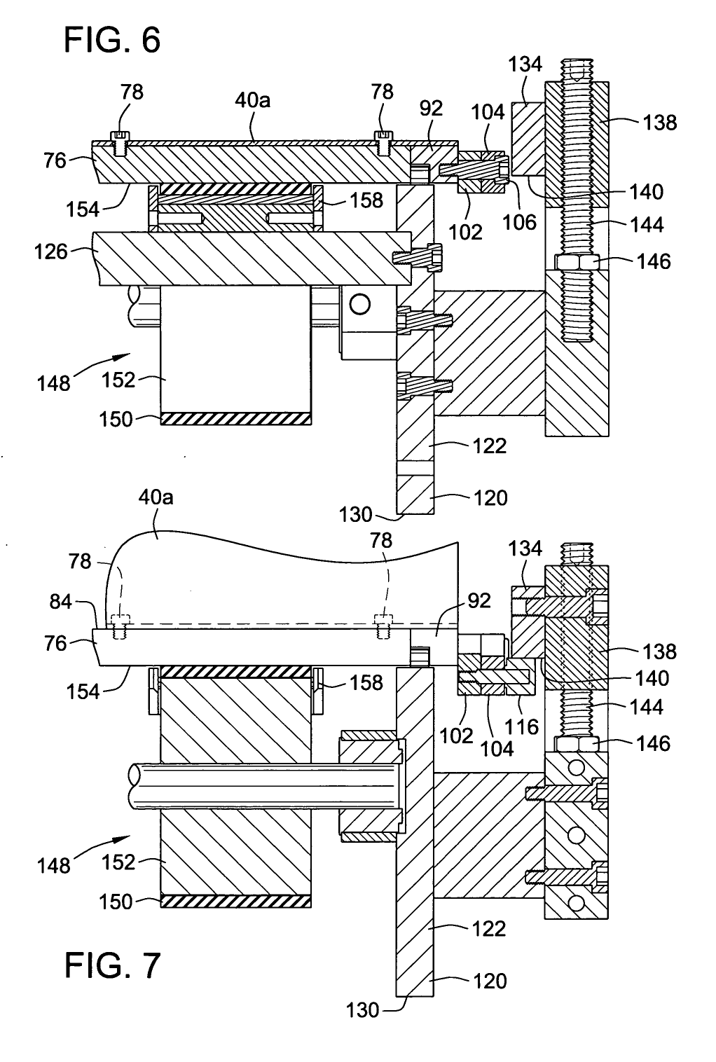

As best seen in FIGS. 6 and 7, each of the adjustment apparatuses 138 includes a threaded rod 144 and a lock nut 146, which may be adjusted to move the second guides 134, 136, in relation to the first guides 130, to thereby change the relative distance between the first and second longitudinal paths 132, 142. Those having skill in the art will recognize that by virtue of the interaction of the articulating linkage 101 with the first and second guides 132, 142, changing the relative distance between the first and second longitudinal paths 132, 144, results in a corresponding change in spacing 28 between adjacent flights 40.

As shown in FIGS. 4-7, and FIG. 9, the conveyor 36 of the exemplary embodiment includes a friction drive mechanism 148, having a pair of longitudinally extending cogged belts 150 running over flange-less pulleys 152. An outer smooth side of the belts 150 is adapted for frictionally contacting a lower surface 154 of the flite support bars 76, in order to impart driving motion to the flites 40.

A central portion 156 of the belt 150 is supported in a flanged belt guide 158 attached to the upper transverse frame member 126 of the conveyor frame 120. Each of the flanged belt guides 158 includes an insert 160 of a low friction material, such as DELRIN, for reducing friction between the bottom sides of the belts 150 and the belt guides 158.

It is contemplated that the conveyor frame 120 will also, preferably, include provisions for adjusting the position of the flanged belt guide 158 vertically so that a desired degree of frictional contact between the flite support bars 76 and the top surfaces of the cogged belts 150. Such provisions may include shims installed between the flanged belt guide 158 and the upper transverse frame members 126, or any other appropriate adjustment mechanism for raising or lowering the flanged belt guides 158 with respect to the flite support bar 176. Alternatively, for example, the thickness of the insert 160 or the belts 150 may be changed to adjust the degree of frictional contact between the belts 150 and the bottom surfaces 154 of the flite support bars 76.

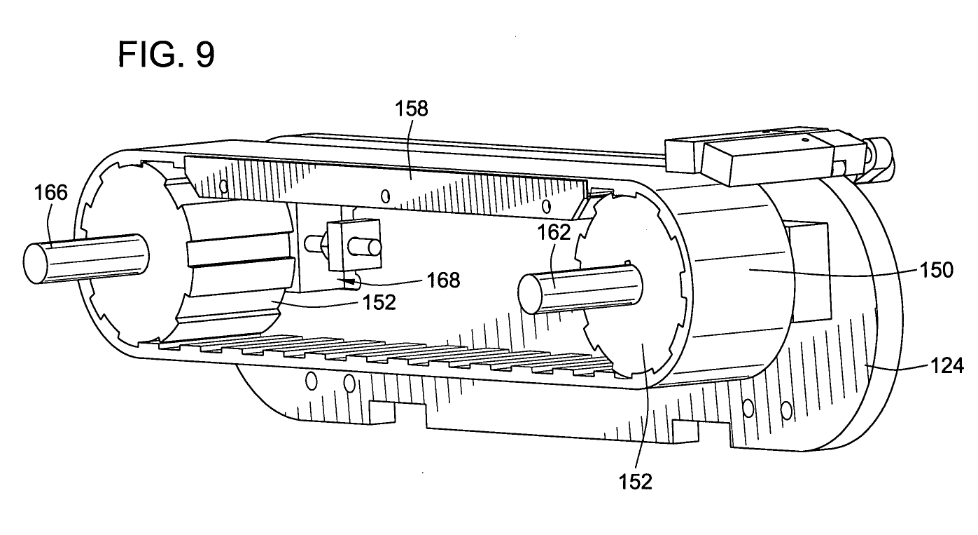

As shown in FIGS. 5 and 9, the front pulleys 152 are keyed to a drive shaft 162, mounted in a fixed location to the frame side plates 122, 124, and extending through one of the side plates 124 for connection to a drive motor 164 which drives the friction drive apparatus 148. As best seen in FIG. 9, the other two pulleys 152 are mounted on an idler shaft 166, which is connected to the side plates 122, 124 of the conveyor frame 120 by a pair of belt tensioners 168 configured for allowing the longitudinal position of the pulleys 152 attached to the idler shaft 166 to be adjusted with respect to the fixed drive shaft 162, in order to set the belt tension at a desired value.

From the forgoing description of exemplary embodiments, those having skill in the art will recognize that the invention provides a method and apparatus for automated fabrication of a self-supporting pleated filter 12, in accordance with the invention. Through simple adjustment of the relative position of the first and second guides 130, 134, 136, of the conveyor 36, the pleat spacing 28 in a pleat pack 14, according to the invention, may be conveniently varied, so that the same automated machine 10 may be utilized for fabricating filters 12 having different desired pleat spacings 28, or different peripheral dimensions. It will also be understood that a conveyor 36, in accordance with the invention, allows the pleat spacing 28 to be varied, within tolerance limits, so that the pleat pack 14 maybe cut exactly on one of the peaks 24 and/or valleys 26 of the convoluted media 18, to facilitate reliable, repetitive automated assembly of the pleat pack 14 into the frame 16 of the filter 12.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A conveyor having a plurality of spaced apart flites operatively joined to one another in such a manner that spacing between the flights is selectively adjustable.

2. The conveyor of claim 1, wherein adjacent flites are joined to one another by an articulating linkage having a first and a second link each having a first end thereof respectively joined in a first articulating joint to one or the other of the adjacent flites and a second end thereof joined together in a common articulating joint with the second end of the other of the first and second links, with the first articulating joints being constrained to follow a first longitudinal path and the common articulating joints being constrained to follow a second longitudinal path spaced from and extending generally parallel to the first longitudinal path, with a relative distance between the first and second longitudinal paths being selectively adjustable, to thereby selectively adjust the spacing between adjacent flites.

3. The conveyor of claim 2, further including a first guide for directing the first articulating joints along the first longitudinal path, and a second guide for directing the common articulating joints along the second longitudinal path.

4. The conveyor of claim 3, further including an adjustment apparatus for moving one of the first and/or second guides with respect to the other of the first and/or second guides, to thereby change the spacing between the first and second longitudinal paths.

5. The conveyor of claim 4, further comprising:
a plurality of flite support bars, having a first surface thereof adapted for attachment thereto of a flite, a second surface thereof adapted for guidance along the first longitudinal path, the flite support bars extending substantially transverse to the longitudinal path, and adapted at first and second ends thereof for articulating attachment of the first ends of adjacent first and second articulating links, with the first and second articulating links joining the first ends of the flite support bars thereby forming a first longitudinally running endless chain, and the first and second articulating links joining the second ends of the flite support bars thereby forming a second longitudinally running endless chain transversely spaced by the flite support bars from the first longitudinally running endless chain; and
a conveyor frame wherein the first guide includes at least one longitudinally extending flite support bar guide for guiding the second surfaces of the flite support bars in such a manner that the first articulating joints are directed along the first longitudinal path, and wherein the conveyor frame further includes a pair of second guides, with one second guide operatively mounted adjacent to each of the first and second ends of the flite support bars for guiding the common articulating joints formed by the articulating links at first and second ends of the flite support bars along respective substantially parallel second longitudinal paths.

6. The conveyor of claim 5, further comprising a friction drive mechanism adapted for contacting the second surface of the flite support bars, to thereby urge movement of the support bars and first articulating joints attached thereto along the first longitudinal path.

7. The conveyor of claim 5, wherein the flite support bar guide includes a substantially flat and straight section thereof defining a pleat spacing region of the first longitudinal path.

8. An apparatus for fabricating a filter element having a convoluted sheet of filter media including a plurality of pleats forming sloping sides thereof extending from alternating peaks and valleys, the apparatus comprising:
a pleat spacer having a conveyor for transporting the filter media along a longitudinal axis;
the conveyor including a plurality of flites extending substantially transverse to the longitudinal axis;
each flite of the conveyor having a first end thereof operatively connected to an adjacent flite of the conveyor and a distal end thereof adapted for engaging a peak of the convoluted sheet, with adjacent flights being spaced apart from one another to form a space therebetween for receiving a valley of the convoluted sheet therein;
the flites of the conveyor being operatively joined to one another in such a manner that spacing between the flights is selectively adjustable, to thereby selectively adjust spacing between the pleats.

9. The apparatus of claim 8, further comprising, a media scorer for scoring a continuous sheet of the filter media, and a bin disposed between the scorer and the conveyor for receiving the continuous sheet of scored media and supplying the continuous sheet of scored media to the conveyor.

10. The apparatus of claim 9, wherein the scorer generates a plurality of longitudinally spaced transversely extending score lines on the continuous sheet of filter media, and the apparatus further comprises a pleat inserter for urging the scored media to fold in such a manner that the media enters the spaces between adjacent flites, at every other score line, to thereby form the valleys of the pleats.

11. The apparatus of claim 8, wherein adjacent flites of the conveyor are joined to one another by an articulating linkage having a first and a second link each having a first end thereof respectively joined in a first articulating joint to one or the other of the adjacent flites and a second end thereof joined together in a common articulating joint with the second end of the other of the first and second links, with the first articulating joints being constrained to follow a first longitudinal path and the common articulating joints being constrained to follow a second longitudinal path spaced from and extending generally parallel to the first longitudinal path, with a relative distance between the first and second longitudinal paths being selectively adjustable, to thereby selectively adjust the spacing between adjacent flites.

12. The apparatus of claim 11, wherein the conveyor further includes a first guide for directing the first articulating joints along the first longitudinal path, and a second guide for directing the common articulating joints along the second longitudinal path.

13. The apparatus of claim 12, wherein the conveyor further includes an adjustment apparatus for moving one of the first and/or second guides with respect to the other of the first and/or second guides, to thereby change the spacing between the first and second longitudinal paths.

14. The apparatus of claim 13, further comprising, a media scorer for scoring a continuous sheet of the filter media, and a bin disposed between the scorer and the conveyor for receiving the continuous sheet of scored media and supplying the continuous sheet of scored media to the conveyor.

15. The apparatus of claim 14, wherein the scorer generates a plurality of longitudinally spaced transversely extending score lines on the continuous sheet of filter media, and the apparatus further comprises a pleat inserter for urging the scored media to fold in such a manner that the media enters the spaces between adjacent flites, at every other score line, to thereby form the valleys of the pleats.

16. The apparatus of claim 15, wherein:
the conveyor also comprises a plurality of flite support bars, having a first surface thereof adapted for attachment thereto of a flite, a second surface thereof adapted for guidance along the first longitudinal path, the flite support bars extending substantially transverse to the longitudinal path, and adapted at first and second ends thereof for articulating attachment of the first ends of adjacent first and second articulating links, with the first and second articulating links joining the first ends of the flite support bars thereby forming a first longitudinally running endless chain, and the first and second articulating links joining the second ends of the flite support bars thereby forming a second longitudinally running endless chain transversely spaced by the flite support bars from the first longitudinally running endless chain; and
the conveyor further comprises a conveyor frame wherein the first guide includes at least one longitudinally extending flite support bar guide for guiding the second surfaces of the flite support bars in such a manner that the first articulating joints are directed along the first longitudinal path, and wherein the conveyor frame further includes a pair of second guides, with one second guide operatively mounted adjacent to each of the first and second ends of the flite support bars for guiding the common articulating joints formed by the articulating links at first and second ends of the flite support bars along respective substantially parallel second longitudinal paths;
the flite support bar guide of the conveyor frame includes a substantially flat and straight section thereof defining a pleat spacing region of the first longitudinal path disposed upstream from a return portion of the first longitudinal path; and
the apparatus further includes a pleated media guide for lifting the pleated media away from the flites prior to the pleated media reaching the return portion of the first longitudinal path.

17. The apparatus of claim 16, further including an apparatus for attaching one or more longitudinally extending reinforcement strips to the peaks of at least some of the pleats as they travel through the plate spacing region of the first longitudinal path.

18. A method of fabricating a pleated filter having pleat pack including a convoluted sheet of filter media having a plurality of pleats forming sloping sides thereof extending from alternating peaks and valleys disposed nominally at a desired pleat spacing within a tolerance limit, the pleat pack also including a cut end thereof, the method comprising adjusting the pleat spacing within the tolerance limit to place the cut end of the pleat pack at a desired location on the convoluted sheet.

19. The method of claim 18, further comprising, adjusting the pleat spacing within the tolerance limit, to place the cut end of the pleat pack at one of the peaks or valleys of the convoluted sheet of filter media.

20. The method of claim 18, further comprising, feeding the sheet of filter media through a pleat spacer having a conveyor for transporting the filter media along a longitudinal axis wherein the conveyor comprises:
a plurality of flites extending substantially transverse to the longitudinal axis, with each flite of the conveyor having a first end thereof operatively connected to an adjacent flite of the conveyor and a distal end thereof adapted for engaging a peak of the convoluted sheet, with adjacent flights being spaced apart from one another to form a space therebetween for receiving a valley of the convoluted sheet therein, and with the flites of the conveyor being operatively joined to one another in such a manner that spacing between the flights is selectively adjustable, to thereby selectively adjust spacing between the pleats.

21. The method of claim 20, wherein adjacent flites of the conveyor are joined to one another by an articulating linkage having a first and a second link each having a first end thereof respectively joined in a first articulating joint to one or the other of the adjacent flites and a second end thereof joined together in a common articulating joint with the second end of the other of the first and second links, and the method further comprises:
constraining the first articulating joints to follow a first longitudinal path and constraining the common articulating joints to follow a second longitudinal path spaced from and extending generally parallel to the first longitudinal path; and
selectively adjusting a relative distance between the first and second longitudinal paths, to thereby selectively adjust the spacing between adjacent flites.

22. The method of claim 21, wherein the conveyor further includes a first guide for directing the first articulating joints along the first longitudinal path, a second guide for directing the common articulating joints along the second longitudinal path, and an adjustment apparatus for moving the second guide with respect to the first guide, to thereby change the spacing between the first and second longitudinal paths, and the method further comprises, selectively adjusting the adjustment guide to thereby change the spacing between the first and second guides.

23. A pleated filter having pleat pack including a convoluted sheet of filter media having a plurality of pleats forming sloping sides thereof extending from alternating peaks and valleys disposed nominally at a desired pleat spacing within a tolerance limit, the pleat pack also including a cut end thereof, wherein the pleat spacing is adjusted within the tolerance limit, during fabrication of the pleat pack, to place the cut end of the pleat pack at a desired location on the convoluted sheet.

24. The filter of claim 23, wherein, during fabrication of the pleat pack, the pleat spacing is adjusted within the tolerance limit to place the cut end of the pleat pack at one of the peaks or valleys of the convoluted sheet of filter media.

25. The filter element of claim 23, wherein, the convoluted sheet of filter media includes an integer value of half pleats forming sloping sides the pleats extending from alternating peaks and valleys, with the pleats being spaced during fabrication of the filter element by a pleat spacer having a conveyor for transporting the filter media along a longitudinal axis;
the conveyor including a plurality of flites extending substantially transverse to the longitudinal axis;
each flite of the conveyor having a first end thereof operatively connected to an adjacent flite of the conveyor and a distal end thereof adapted for engaging a peak of the convoluted sheet, with adjacent flights being spaced apart from one another to form a space therebetween for receiving a valley of the convoluted sheet therein;
the flites of the conveyor being operatively joined to one another in such a manner that spacing between the flights is selectively adjustable, to thereby selectively adjust spacing between the pleats; and
the pleats being held at a selected spacing by the pleat spacer, during fabrication of the filter, with the spacing being varied by the pleat spacer, if necessary, to achieve a desired.

26. The filter element of claim 25, further comprising at least one longitudinally extending reinforcement strip attached to the peaks of at least some of the pleats, while the pleats are held in the selected spacing by the pleat spacer.
